(19) United States
(12) Patent Application Publication
(10) Pub. No.: US 2010/0332576 A1
(43) Pub. Date: Dec. 30, 2010

(54) APPARATUS AND METHOD OF CALCULATING SQUARE ROOT IN FINITE EXTENSION FIELD

(75) Inventors: Dongguk Han, Daejeon (KR); Howon Kim, Daejeon (KR); Kyoil Chung, Daejeon (KR)

Correspondence Address: AMPACC Law Group, PLLC;LOADING..., 6100 219th Street SW, Suite 580, Mountlake Terrace, WA, 98043, US

(73) Assignee: Electronics and Telecommunications Research Institute, Daejeon (KR)

(21) Appl. No.: 12/677,259

(22) PCT Filed: Aug. 28, 2008
(86) PCT No.: PCT/KR08/05039

§ 371 Date: Mar. 9, 2010

(30) Foreign Application Priority Data
Sep. 10, 2007 (KR) 10-2007-0091588

(51) Int. Cl. G06F 7/552; G06F 1/02

(52) U.S. Cl. 708/277

(57) ABSTRACT

Disclosed is an apparatus and a method of calculating the square root of an element a, which is not zero, belonging to a finite extension field F_{pAk} (where p is a prime number satisfying p≡3(mod 4) and k is an odd number). The method includes: calculating a common exponentiation formula that is common to an exponentiation formula for calculating a quadratic residue, which is used to determine whether the square root of the element a is present, and an exponentiation formula for calculating the square root of the element a when it is determined that the square root of the element a is present; determining the result obtained by multiplying the square of the common exponentiation formula by the element a as the quadratic residue; and determining the result obtained by multiplying the common exponentiation formula by the element a as the square root of the element a.

### TECHNICAL FIELD

The present invention relates to an apparatus and a method of calculating a square root in a finite extension field, and more particularly, to an apparatus and a method of determining whether a square root is present on the basis of the calculation result of a quadratic residue and calculating the square root which is determined to be present.

This work was supported by the IT R&D program of MIC/IITA [2005-S-088-03, Development of Security Technology for Secure RFID/USN Service].

### BACKGROUND ART

A finite extension field having a number of p^{k} elements is represented by

Fₚ_{^{k}}

(where p, which is a characteristic, is a prime number and k, which is an exponent, is an odd number). In order to calculate the square root of an arbitrary element a, which is represented by a polynomial and is not zero, belonging to the finite extension field, the following two processes are required: a first process of checking whether the square root of the element is present; and a second process of, when it is checked that the square root of the element is present, calculating the square root of the element.

The method of calculating the square root in the finite extension field can be utilized in various technical fields required for calculating the square root, particularly, an information security (cryptology) field. For example, in an elliptic curve cryptosystem, generally, an element on an elliptic curve can be represented by two coordinates (x, y). In this case, when an application protocol based on the elliptic curve cryptosystem is configured, two coordinate values should be transmitted in order to establish the protocol. However, when both of the two coordinate values are transmitted, data transmission efficiency is lowered. Therefore, a technique that is capable of achieving the same effect as that of transmitting both of the two coordinates by instead transmitting only the x coordinate of the two coordinates and an additional one bit (0 or 1) has been demanded. A method of effectively calculating a square root can meet the demands.

The first process of checking whether the square root of an arbitrary element is present can be achieved by Math FIG. 1 given below:

$$\begin{matrix}MathFigure 1 & \\ {a}^{\frac{{p}^{k} - 1}{2}} = \{ \begin{matrix}1 , \\ - 1 ,\end{matrix} & [ Math . 1 ]\end{matrix}$$

Math FIG. 1 represents the calculation result of a quadratic residue for the element a. The result of the calculation, when the value of the quadratic residue is 1, is such that the square root of the element a is present in the finite extension field

Fₚ_{^{k.}}

When the value of the quadratic residue is −1, the square root of the element a is absent in the finite extension field

Fₚ_{^{k.}}

The result of the calculation in Math FIG. 1, when the value of the quadratic residue is 1, is such that the square root of the element a is calculated in the second process. Various methods can be used to calculate the square root according to the conditions of the characteristic p. For example, if the condition is p≡3(mod 4), the square root is calculated by Math FIG. 2 given below:

MathFigure 2
[Math.2]

Input: a ∈ Fₚ_{^{k}}.
Output: x satisfying x² = a in Fₚ_{^{k}}.
$1 \text{:} x ← {a}^{\frac{{p}^{k} + 1}{4}} .$
2: return x

In Math FIG. 2, an output x for the input of the element a belonging to the finite extension field

$${F}_{{p}^{k}} is {a}^{\frac{{p}^{k} + 1}{4}} ,$$

and the output x is the square root of the element a.

That is, a total of two exponentiation calculations are needed to calculate the square root of an arbitrary element in the finite extension field.

Meanwhile, the following paper discloses an efficient method of calculating the square root of an arbitrary element in a finite extension field if the condition of a characteristic is p≡3(mod 4): P. S. L. M. Barreto, H. y. Kim, B. Lynn, and M. Scott, “Efficient Algorithms for Pairing-Based Cryptosystems” Lecture Notes in Computer Science vol. 2442, pp. 354-369, 2002.

Korean Patent Application No. 2005-0069881 discloses a device and method for calculating the square root of an input real number.

### DISCLOSURE OF INVENTION

### Technical Problem

The above-mentioned paper discloses an efficient method of calculating the square root of an arbitrary element in a finite extension field finite extension field. However, in this paper, a process of determining whether the square root of the element is present should be performed before a process of calculating the square root using a separate algorithm, and a total of two exponentiation calculations are needed to calculate the square root. Therefore, the method is insufficient and it takes a long time for a computer to compute the square root.

Since Korean Patent Application No. 2005-0069881 discloses only a method of calculating the square root of an input real number, it cannot be applied to a method of calculating the square root of an arbitrary element in a finite extension field.

The invention is designed to solve the above problems, and an object of the invention is to provide a square root calculating method capable of removing replication between a process of checking whether the square root of an arbitrary element belonging to a finite extension field is present and a process of determining the square root, thereby minimizing the number of calculations of exponentiation.

Another object of the invention is to provide a method of calculating the square root of an arbitrary element belonging to a finite extension field that is capable of minimizing the number of calculations of exponentiation using an exponentiation factor that is common to a calculating formula for checking whether the square root of the element is present and a calculating formula for calculating the square root.

Still another object of the invention is to determine whether the square root of an arbitrary element belonging to a finite extension field is present and calculate the square root using a unified algorithm.

### Technical Solution

In order to achieve the above objects, according to a first aspect of the invention, there is provided a method of calculating the square root of an element a, which is not zero, belonging to a finite extension field that has a number of p^{k} elements (where p is a prime number satisfying p≡3(mod 4) and k is an odd number). The method includes: calculating a common exponentiation formula that is common to a quadratic residue exponentiation formula for calculating a quadratic residue, which is used to determine whether the square root is present, and a square root exponentiation formula for calculating the square root; determining the result obtained by multiplying the common exponentiation formula by the element a as the square root; determining the result obtained by multiplying the common exponentiation formula by the determined square root as the quadratic residue; determining whether the square root of the element a is present on the basis of the determined quadratic residue; and when it is determined that the square root of the element a is present, outputting the determined square root as the square root of the element a.

According to a second aspect of the invention, there is provided a method of calculating the square root of an element a, which is not zero, belonging to a finite extension field that has a number of p^{k} elements (where p is a prime number satisfying p≡3(mod 4) and k is an odd number). The method includes: calculating a common exponentiation formula that is common to a quadratic residue exponentiation formula for calculating a quadratic residue, which is used to determine whether the square root is present, and a square root exponentiation formula for calculating the square root; determining the result obtained by multiplying the square of the common exponentiation formula by the element a as the quadratic residue; determining whether the square root of the element a is present on the basis of the determined quadratic residue; and when it is determined that the square root of the element a is present, outputting the result obtained by multiplying the common exponentiation formula by the element a as the square root of the element a.

According to the first aspect of the invention, it is possible to determine whether the square root of an element is present and calculate the square root of the element with only one exponentiation calculation and several multiplications using a unified algorithm, which results in an operating speed increase of 50% or more, as compared to the related art that requires separate algorithms and a total of two exponentiation calculations to determine whether the square root of an element is present and calculate the square root of the element. In particular, when an algorithm for calculating a square root according to the invention is implemented by a hardware component using a parallel technique, it is possible to further improve an operation speed. Further, according to the second aspect of the invention, when there is not a square root of an element a, it is not necessary to calculate the square root beforehand.

### ADVANTAGEOUS EFFECTS

According to the invention, it is possible to remove replication between a process of checking whether the square root of an arbitrary element belonging to a finite extension field is present and a process of determining the square root, and thus minimize the number of calculations of exponentiation, which results in an increase in the operation speed. Further, according to the invention, in the calculation of the square root of an arbitrary element belonging to a finite extension field, an exponentiation factor that is common to a calculating formula for checking whether the square root of the element is present and a calculating formula for calculating the square root is used, which makes it possible to minimize the number of calculations of exponentiation. Furthermore, according to the invention, it is possible to determine whether the square root of an arbitrary element belonging to a finite extension field is present and calculate the square root using a unified algorithm.

### BRIEF DESCRIPTION OF THE DRAWINGS

FIG. 1 is a diagram illustrating the structure of an apparatus for calculating a square root according to a first embodiment of the invention.

FIG. 2 is a flowchart illustrating a method of calculating a square root according to the first embodiment of the invention.

FIG. 3 is a diagram illustrating the structure of an apparatus for calculating a square root according to a second embodiment of the invention.

FIG. 4 is a flowchart illustrating a method of calculating a square root according to the second embodiment of the invention.

### BEST MODE FOR CARRYING OUT THE INVENTION

Hereinafter, exemplary embodiments of the invention will be described with reference to the accompanying drawings.

### First Embodiment

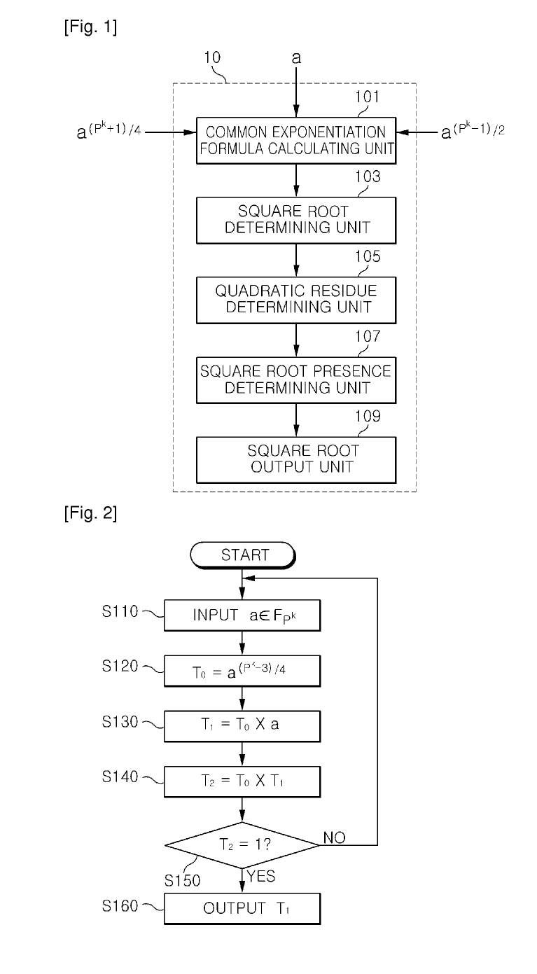

FIG. 1 shows a square root calculating apparatus 10 that executes a method of calculating a square root in a finite extension field according to a first embodiment of the invention. The apparatus 10 includes a common exponentiation formula calculating unit 101, a square root determining unit 103, a quadratic residue determining unit 105, a square root presence determining unit 107, and a square root output unit 109. The apparatus and functional units described herein may be implemented by general hardware structures, such as a processor, a memory, and an I/O unit in a computer system, and application program software cooperating with these hardware structures.

The common exponentiation formula calculating unit 101 calculates an exponentiation formula

T₀=a^{(p}^{^{k}}^{-3)/4}

that is common to a quadratic residue exponentiation formula (Math FIG. 1) that calculates a quadratic residue used to determine whether the square root of an element a, which is not zero, belonging to a finite extension field

Fₚ_{^{k}}

(where p≡3(mod 4), and k is an odd number) is present and a square root exponentiation formula (an output x of Math FIG. 2) that is used to calculate the square root. For example, the common exponentiation formula is obtained by dividing the quadratic residue exponentiation formula by the square root exponentiation formula.

The square root determining unit 103 determines T₁=T₀×a as the square root of the element a, which is identical to the output x of Math FIG. 2.

The quadratic residue determining unit 105 determines T₂=T₀×T₁ as a quadratic residue that is used to determine whether the square root of the element a is present, which is identical to Math FIG. 1.

When the value of a quadratic residue T₂ determined by the quadratic residue determining unit 105 is 1, the square root presence determining unit 107 determines that the square root of the element a is present. When the value of the quadratic residue T₂ is −1, the square root presence determining unit 107 determines that the square root of the element a is absent.

When the square root presence determining unit 107 determines that the square root of the element a is present, the square root output unit 109 outputs the value T₁ determined by the square root determining unit 103 as the square root of the element a.

FIG. 2 is a flowchart illustrating a method of calculating a square root performed by the square root calculating apparatus 10 according to this embodiment.

When the element a, which is not zero, belonging to the finite extension field is input to the apparatus 10 (S110), the common exponentiation formula calculating unit 101 calculates a common exponentiation formula

T₀=a^{(p}^{^{k}}^{-3)/4}

(S120), and then the square root determining unit 103 determines T₁=T₀×a as the square root of the element a (S130). Then, the quadratic residue determining unit 105 determines T₂=T₀×T₁ as a quadratic residue (S140).

The square root presence determining unit 107 determines whether the value of the quadratic residue T₂ is 1 (S150). When it is determined that the value of the quadratic residue T₂ is 1, the square root output unit 109 outputs the value T₁ as the square root of the element a. (S160). If not, the process returns to Step S110 to wait for a new input.

According to this embodiment, it is possible to determine whether the square root of an element is present and calculate the square root of the element with only one exponentiation calculation

(T₀=a^{(p}^{^{k}}^{-3)/4})

and several multiplications using a unified algorithm, which results in an operating speed increase of 50% or more, as compared to the related art that requires separate algorithms and a total of two exponentiation calculations to determine whether the square root of an element is present and to calculate the square root of the element. In particular, when an algorithm for the method of calculating a square root according to this embodiment is implemented by a hardware component using a parallel technique, it is possible to further improve the operation speed.

### Second Embodiment

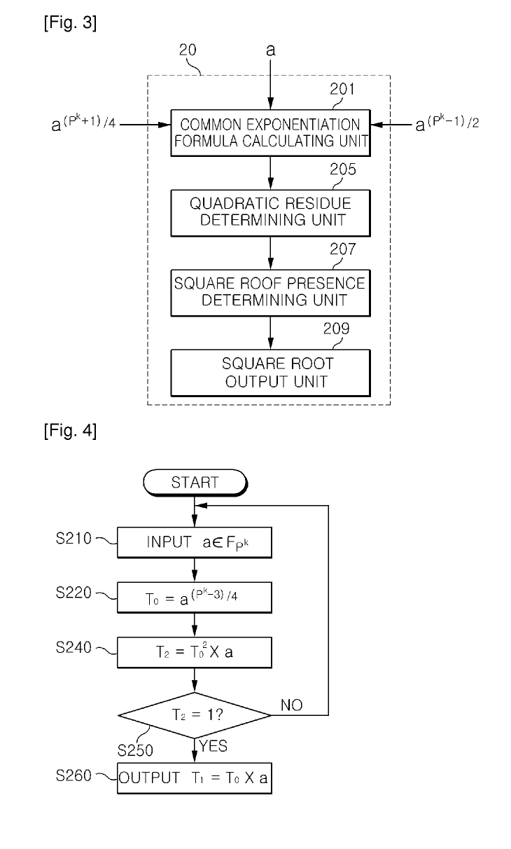

FIG. 3 is a diagram illustrating the procedure of an apparatus 20 for calculating a square root in a finite extension field according to a second embodiment of the invention, and FIG. 4 is a flowchart illustrating a method of calculating a square root in the finite extension field. The apparatus 20 includes a common exponentiation formula calculating unit 201, a quadratic residue determining unit 205, a square root presence determining unit 207, and a square root output unit 209.

The second embodiment differs from the first embodiment in that the square root calculating unit 103 is not needed, which makes it unnecessary to calculate a square root T₁ beforehand. Therefore, in addition to the advantages of the first embodiment, the second embodiment has an advantage in that it is unnecessary to calculate the square root of the element a beforehand, which may be absent. In FIG. 4, Steps S210, S220, S240, and S250 correspond to Steps S110, S120, S140, and S150 in FIG. 2, respectively. In this embodiment, Steps S130 and S160 in FIG. 2 are integrated into Step S260 in FIG. 4.

In this embodiment, the common exponentiation formula calculating unit 201 calculates a common exponentiation formula T₀, similar to the first embodiment. The quadratic residue determining unit 205 determines

T₂=T₀²×a

as a quadratic residue, and the square root presence determining unit 207 determines whether the quadratic residue is present on the basis of the value of the quadratic residue

T₂=T₀²×a,

similar to the first embodiment. When the square root presence determining unit 207 determines that the square root is present, the square root output unit 209 outputs T₁=T₀×a as the square root of the element a.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. For example, when a common exponentiation formula is determined as −T₀, multiplying the common exponentiation formula by −a and multiplying the square of the common exponentiation formula by −a are the equivalents of the invention.

1. A method of calculating a square root of an element a, which is not zero, belonging to a finite extension field that has a number of p^{k} elements (where p is a prime number satisfying p≡3(mod 4) and k is an odd number), the method comprising:
calculating a common exponentiation formula that is common to a quadratic residue exponentiation formula for calculating a quadratic residue, which is used to determine whether the square root is present, and a square root exponentiation formula for calculating the square root;
determining the result obtained by multiplying the common exponentiation formula by the element a as the square root;
determining the result obtained by multiplying the common exponentiation formula by the determined square root as the quadratic residue;
determining whether the square root of the element a is present on the basis of the determined quadratic residue; and
when it is determined that the square root of the element a is present, outputting the determined square root as the square root of the element a.

2. A method of calculating a square root of an element a, which is not zero, belonging to a finite extension field that has a number of p^{k} elements (where p is a prime number satisfying p≡3(mod 4) and k is an odd number), the method comprising:
calculating a common exponentiation formula that is common to a quadratic residue exponentiation formula for calculating a quadratic residue, which is used to determine whether the square root is present, and a square root exponentiation formula for calculating the square root;
determining the result obtained by multiplying the square of the common exponentiation formula by the element a as the quadratic residue;
determining whether the square root of the element a is present on the basis of the determined quadratic residue; and
when it is determined that the square root of the element a is present, outputting the result obtained by multiplying the common exponentiation formula by the element a as the square root of the element a.

3. The method of claim 1,
wherein the quadratic residue exponentiation formula is represented by
$${a}^{\frac{{p}^{k} - 1}{2}} ,$$
the square root exponentiation formula is represented by
$${a}^{\frac{{p}^{k} + 1}{4}} ,$$
and
the common exponentiation
$${a}^{\frac{{p}^{k} - 3}{4}}$$
formula is represented by which is obtained by dividing the quadratic residue exponentiation formula by the square root exponentiation formula.

4. The method of claim 1,
wherein, in the determining of the presence of the square root, when the value of the determined quadratic residue is 1, it is determined that the square root of the element a is present.

5. An apparatus for calculating a square root of an element a, which is not zero, belonging to a finite extension field that has a number of p^{k} elements (where p is a prime number satisfying p≡3(mod 4) and k is an odd number), the apparatus comprising:
a common exponentiation formula calculating unit for calculating a common exponentiation formula that is common to a quadratic residue exponentiation formula for calculating a quadratic residue, which is used to determine whether the square root is present, and a square root exponentiation formula for calculating the square root;
a square root determining unit for determining the result obtained by multiplying the common exponentiation formula by the element a as the square root;
a quadratic residue determining unit for determining the result obtained by multiplying the common exponentiation formula by the determined square root as the quadratic residue;
a square root presence determining unit for determining whether the square root of the element a is present on the basis of the determined quadratic residue; and
a square root output unit for outputting the determined square root as the square root of the element a when it is determined that the square root of the element a is present.

6. An apparatus for calculating a square root of an element a, which is not zero, belonging to a finite extension field that has a number of p^{k} elements (where p is a prime number satisfying p≡3(mod 4) and k is an odd number), the apparatus comprising:
a common exponentiation formula calculating unit for calculating a common exponentiation formula that is common to a quadratic residue exponentiation formula for calculating a quadratic residue, which is used to determine whether the square root is present, and a square root exponentiation formula for calculating the square root;
a quadratic residue determining unit for determining the result obtained by multiplying the square of the common exponentiation formula by the element a as the quadratic residue;
a square root presence determining unit for determining whether the square root of the element a is present on the basis of the determined quadratic residue; and
a square root output unit for outputting the result obtained by multiplying the common exponentiation formula by the element a as the square root of the element a when it is determined that the square root of the element a is present.

7. The apparatus of claim 5,
wherein the quadratic residue exponentiation formula is represented by
$${a}^{\frac{{p}^{k} - 1}{2}} ,$$
the square root exponentiation formula is represented by
$${a}^{\frac{{p}^{k} + 1}{4}} ,$$
and
the common exponentiation formula is represented by
$${a}^{\frac{{p}^{k} - 3}{4}}$$
which is obtained by dividing the quadratic residue exponentiation formula by the square root exponentiation formula.

8. The apparatus of claim 5,
wherein, the square root presence determining unit determines that the square root of the element a is present when the value of the determined quadratic residue is 1.

9. An apparatus for calculating a square root of an element a, which is not zero, belonging to a finite extension field that has a number of p^{k} elements (where p is a prime number satisfying p≡3(mod 4) and k is an odd number), characterized by using a common exponentiation formula that is common to a quadratic residue exponentiation formula for calculating a quadratic residue, which is used to determine whether the square root is present, and a square root exponentiation formula for calculating the square root to calculate the quadratic residue and the square root.
